(19) United States
(12) Patent Application Publication
(10) Pub. No.: US 2023/0148325 A1
(43) Pub. Date: May 11, 2023

(54) PHYTOSANITARY COMPOSITION COMPRISING ULVANS AND SILICON

(71) Applicant: AGRO INNOVATION INTERNATIONAL, SAINT-MALO (FR)

(72) Inventors: Éric NGUEMA-ONA, SAINT-MALO (FR); Jean-Claude YVIN, SAINT-MALO (FR)

(21) Appl. No.: 17/910,934

(22) PCT Filed: Mar. 12, 2021
(86) PCT No.: PCT/FR2021/050420

§ 371 Date: Sep. 12, 2022

(30) Foreign Application Priority Data
Mar. 13, 2020 (FR) FR2002511

(51) Int. Cl. A01N 43/16; A01N 59/00; A01N 65/03

(52) U.S. Cl. CPC A01N 43/16; A01N 59/00; A01N 65/03

(57) ABSTRACT

The invention relates to a phytosanitary composition comprising (i) ulvans and/or ulvan-derived oligosaccharides, for example in the form of an extract containing ulvans and/or ulvan-derived oligosaccharides; and (ii) silicon, to the use of said composition for activating plant defense reactions and resistance against biotic stresses, and also to a method for activating plant defense reactions and resistance against biotic stresses, which involves applying to said plant an effective amount of the phytosanitary composition.

### TECHNICAL FIELD

The invention relates to a phytosanitary composition comprising (i) ulvans and/or ulvan-derived oligosaccharides, for example in the form of an extract containing ulvans and/or ulvan-derived oligosaccharides; and (ii) silicon, to the use of said composition for activating plant defense reactions and resistance against biotic stresses, and also to a method for activating plant defense reactions and resistance against biotic stresses, which involves applying to said plant an effective amount of the composition.

### PRIOR ART

Plants can be attacked by a multitude of pathogens (such as fungi, bacteria, viruses, viroids, protozoa, nematodes, herbivores) resulting in yield losses and reduced quality of production.

To reinforce the protection of plants against these pathogens, chemical agents, for example pesticides, can be used. However, pesticides today represent a potential danger for humans and/or the environment. Thus, new phytosanitary strategies have been developed, by means of studying the defense mechanisms of plants.

Indeed, although lacking an immune system similar to that of higher animals, plants have their own defense arsenal. Knowledge of these mechanisms makes it possible to envision exploiting them to combat diseases.

Plant defense mechanisms may involve a series of events triggered in or on the surface of plant cells when the plant is attacked by a pathogen, such as the recognition of the pathogen, the sending of this information to the nucleus, the induction of defense genes followed by the synthesis of antimicrobial compounds and “PR” (pathogenesis-related) proteins, and the transmission of the alarm signal to the whole plant and to its neighbors.

Thus, to increase the response capacity and hence the resistance of a plant toward certain pathogens, one of the possible strategies consists in inducing defense reactions prior to the attack of the pathogen by using signal molecules. These signal molecules, which are of very varied chemical nature (proteins, peptides, glycoproteins, lipids and oligosaccharides) are capable of transmitting the information of an attack even at very low concentration.

They are mostly of microbial origin (for example harpin) or of plant origin (for example oligogalacturonic acids) or chemically synthesized (for example benzothiadiazole) or of mineral origin (for example phosphite salts).

In response to treatments with these signal molecules, the plant reacts by synthesizing structural proteins, which strengthen the plant cell wall, enzymes involved in the synthesis of antimicrobial compounds such as phytoalexins, hydrolases such as chitinases or glucanases and inhibitory enzymes which act against the hydrolytic enzymes of the pathogens. The establishment of these means of defense proceeds via the activation in the plant of hormonal signaling (presence of or increase in the concentration of phytohormones such as salicylic acid and/or derivatives thereof, and/or jasmonic acid and/or derivatives thereof), but also via the induction of defense genes, coding for defense enzymes (hydrolases, chitinases), coding for “PR” (pathogenesis-related) proteins, or genes coding for biosynthetic enzymes of defense metabolites (phytoalexins), or the reinforcement of structural barriers (i.e. parietal reinforcement).

Activation of the plant immune system by signaling molecules brings about the synthesis and deposition of phenolic compounds and defense proteins in the wall, the accumulation of antimicrobial compounds, and the synthesis of “PR” proteins. Parietal reinforcement, which can slow down or inhibit pathogen progression inside the plant, results, for example, from the deposition of callose in the wall or plasmodesmata, and also from the synthesis of lignins. These mechanisms makes it possible to slow down fungal or viral invasions. Similarly, HRGP extensins (Hydroxyproline-Rich GlycoProtein) and GRPs (glycine-rich protein) can, by their role in reinforcing the wall, make said wall more difficult to degrade.

Phytoalexins, which are low molecular weight antimicrobial compounds, make it possible in certain cases to directly combat parasites, because of their capacity to accumulate rapidly around the point of infection, thus preventing the progression of the invasion. PR proteins (intracellular or extracellular) accumulate in plants after inoculation by pathogens and, in the case of incompatible interactions, can constitute up to 10% of the soluble proteins of the leaf. For some of them, an active role in the degradation of the wall of fungal pathogens (β-glucanase, chitinase) has been shown.

It should be noted that the three abovementioned phenomena (wall reinforcement, phytoalexin synthesis and PR protein synthesis) accompany the activation of the plant immune system without being exclusive thereto. Indeed, the synthesis of GRP and HRGP proteins has also been detected during compatible interactions, and also following injury.

Activation of the plant immune system can also be accompanied by the synthesis of signaling molecules, such as salicylic acid and/or derivatives thereof, and/or jasmonic acid and/or derivatives thereof, which are phytohormones involved in the plant defense process.

Marine algae are an abundant plant resource and have been used for a long time in coastal regions as soil fertilizers. Seed germination, higher yields, resistance to diseases and longer shelf life of fruits have been demonstrated by treating several plants with algal extracts. The findings as regards plant health were mainly attributed to the richness in betaines, phytohormones and trace elements of the algae used.

It is now recognized that certain oligosaccharides of marine origin have an elicitor effect on certain plant defense pathways. Thus, WO 99/03346 describes the use of β(1-3) glucan oligosaccharides notably extracted from the brown alga Laminaria digitata for potentiating and stimulating the natural defenses of wheat infected with septoria. These β(1-3) glucans also induce in tobacco cells four defense markers including phenylammonialyase (PAL) activity, which is a key enzyme for the synthesis of phytoalexins, and O-methyl transferase (OMT) activity, which is an enzyme involved in lignin synthesis.

In the case of red algae, it has been shown that carrageenan induces the expression of genes coding for sesquiterpene cyclase, chitinase and proteinase inhibitors.

In the case of green algae, WO 2005/094 588 describes the use of ulvans or ulvan-derived oligosaccharides as activators of plant defense reactions and resistance against biotic or abiotic stresses. However, there is still a need to find new compositions, which would increase the response capacity and thus the resistance of a plant, for example by activating additional and complementary protection mechanisms of the plant, which may involve stimulating the production of salicylic acid and/or derivatives thereof and/or jasmonic acid and/or derivatives thereof, but also the induction of other defense genes, coding for defense enzymes (hydrolases, chitinases), coding for “PR” proteins, or genes coding for biosynthetic enzymes of defense metabolites (phytoalexins), or even for parietal reinforcement.

It is in this context that the Applicant has demonstrated, and this forms the basis of the present invention, that a phytosanitary composition comprising:

(i) ulvans and/or ulvan-derived oligosaccharides, for example in the form of an extract containing ulvans and/or ulvan-derived oligosaccharides; and
(ii) silicon
can stimulate the expression of the defense genes of a plant, notably to induce the production of salicylic acid and/or derivatives thereof, and/or jasmonic acid and/or derivatives thereof, and can thus be used to activate defense reactions of a plant and resistance against biotic stresses. Such a composition can be used alone or in combination with pesticides, for example fungicides. In combination with pesticides, it makes it possible to activate plant defense reactions and resistance against biotic stresses with a reduced amount of pesticides compared to pesticides alone.

### SUMMARY OF THE INVENTION

The present invention, which finds application in the agro-ecological and agricultural sector, is directed toward proposing a new phytosanitary composition, for activating plant defense reactions and resistance against biotic stresses.

According to a first aspect, the invention relates to a phytosanitary composition comprising:

(i) ulvans and/or ulvan-derived oligosaccharides, for example in the form of an extract containing ulvans and/or ulvan-derived oligosaccharides; and
(ii) silicon.

According to a second aspect, the invention relates to the use of the composition as defined above, for activating plant defense reactions and resistance against biotic stresses.

According to a third aspect, the invention relates to a method for activating plant defense reactions and resistance against biotic stresses, which involves applying to said plant an effective amount of the composition as defined above.

### DETAILED DESCRIPTION

In the context of the present invention, the term “phytosanitary composition” is understood to mean any product whose use is intended to treat or prevent diseases of a plant. In the context of the present invention, a phytosanitary composition makes it possible to activate the defense reactions of a plant and to induce resistance against biotic stresses.

In the context of the present invention, the term “ulvans” is understood to denote water-soluble polysaccharides, which are notably present in the cell walls of green algae of the genera Ulva and Enteromorpha. Ulvans are defined more precisely as highly sulfated acidic polysaccharides and are essentially composed of units derived from rhamnose 3-sulfate, xylose, xylose 2-sulfate, glucuronic acid and iduronic acid. The following four repeating units are notably characteristic of ulvans:

Formula (I) shows the group >4)-beta-D-GlcA-(1>4)-alpha-L-Rha 3 sulfate (1>, also called ulvanobiouronic acid 3-sulfate type A:

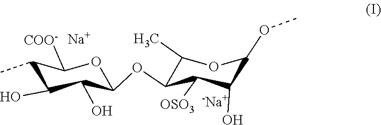

Formula (II) shows the group >4)-alpha-L-IdoA-(1>4)-alpha-L-Rha 3 sulfate(1>, also called ulvanobiuronic acid 3-sulfate type B:

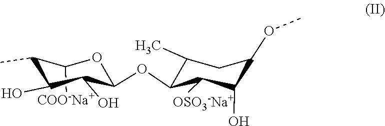

Formula (III) shows the group >4)-beta-D-Xyl-(1>4)-alpha-L-Rha 3 sulfate(1>, also called ulvanobiose acid 3-sulfate:

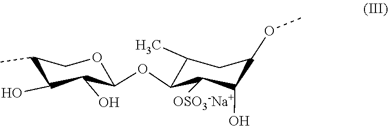

Formula (IV) shows the group >4)-beta-D-Xyl 2-sulfate-(1>4)-alpha-L-Rha 3 sulfate (1>, also called ulvanobiose acid 2′,3-disulfate:

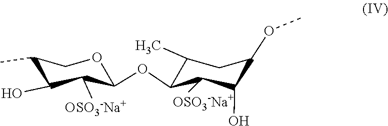

The term “ulvan-derived oligosaccharides” refers in the context of the invention to oligosaccharides obtained by acid hydrolysis of ulvans, for example by hot acid hydrolysis (for example at 85° C.), or by enzymatic hydrolysis of ulvans, for example using one or more glycosidases.

The term “extract” refers to the product resulting from extraction from a source, for example from a biological source, such as cells. When cells are involved, the term “extract” thus denotes the product resulting from the extraction of cell contents. Thus, for example, the term “Ulva extract” denotes the product resulting from the extraction of the content of Ulva cells.

The terms “extract containing ulvans and/or ulvan-derived oligosaccharides” and “extract of ulvans and/or ulvan-derived oligosaccharides” are interchangeable and refer to an extract obtained from a source of ulvans and/or of ulvan-derived oligosaccharides. An extract containing ulvans used in the present invention is preferably an ulvan-containing algal extract, more preferentially an extract of Ulva or an extract of Enteromorpha, for example an extract of Ulva armoricana, an extract of Ulva rigida, an extract of Ulva rotundata, an extract of Ulva lactuca, an extract of Enteromorpha intestinalis, or an extract of Enteromorpha compressa, preferably an extract of Ulva armoricana, an extract of Enteromorpha intestinalis or an extract of Enteromorpha compressa. An extract containing ulvan-derived oligosaccharides may be obtained by acid hydrolysis or enzymatic hydrolysis of an extract containing ulvans, for example of an extract containing ulvans as defined above.

The extract containing ulvans and/or ulvan-derived oligosaccharides may be enriched in ulvans and/or in ulvan-derived oligosaccharides. Techniques for enrichment in ulvans and/or ulvan-derived oligosaccharides are described in the literature and are easy to implement by a person skilled in the art, for example precipitation by addition of ammonium sulfate, by addition of ethanol or by filtration. The concentration of ulvans and/or ulvan-derived oligosaccharides in the extract is preferably at least 1 g/L, preferably at least 10 g/L, at least 11 g/L, at least 12 g/L, at least 13 g/L, at least 14 g/L, at least 15 g/L, at least 16 g/L, at least 17 g/L, at least 18 g/L, at least 19 g/L, for example between 1 and 200 g/L, preferably between 10 and 100 g/L, more preferentially between 15 and 50 g/L, for example about 20 g/L.

The extraction conditions and the nature of the algae will be chosen such that the extract obtained has the desired concentration in the envisioned application. For example, the concentration of ulvans and/or ulvan-derived oligosaccharides varies according to the preparation method. The concentration of ulvans may notably vary depending on the amount of fresh and/or dry algae used (for example, in an aqueous extraction, when the ratio of algae to water is increased, the concentration of ulvans and/or ulvan-derived oligosaccharides in the extract obtained also increases), the extraction time (for example, increasing the extraction time in an aqueous extraction generally increases the concentration of ulvans and/or ulvan-derived oligosaccharides in the extract obtained) and/or the extraction temperature (for example, increasing the extraction temperature in an aqueous extraction generally increases the concentration of ulvans and/or ulvan-derived oligosaccharides in the extract obtained).

The preparation of an extract of ulvans and/or ulvan-derived oligosaccharides does not present any particular difficulty: many extraction methods or processes are described in the literature. The extraction method is not limited to any particular method, and conventional methods can be used to prepare an extract containing ulvans and/or ulvan-derived oligosaccharides, for instance aqueous extraction. An extract of ulvans and/or ulvan-derived oligosaccharides may be obtained, for example, by a method including the following steps: washing, grinding, extraction (solid-liquid separation) and optionally fractionation and concentration. The extract obtained may be more or less concentrated depending on the envisioned use. Total dehydration of this extract makes it possible to obtain an extract in water-soluble powder form which can be obtained, for example, by means of a drum dryer or by atomization.

For the purposes of the invention, the term “silicon” means the chemical element whose symbol is Si, in all its forms. This notably includes silica (also known as “silicon oxide”), silicates (for example SiO₃²⁻ and SiO₄⁴⁻) and combined silicates. Silica exists in the free state in crystalline or amorphous forms. In its crystalline form, silica occurs in the form of non-molecular crystals formed from SiO₄ tetrahedral units linked together by oxygen atoms in a regular manner, as in quartz. In its amorphous form, silica occurs in the form of silicon dioxide (SiO₂), as in glass. Silicon can, for example, be in the form of solid mineral silica, such as diatomaceous earth or sand, in the form of liquid mineral silica, such as orthosilicic acid, in the form of vitreous silicon-based products, such as glass powders or glass fibers, in the form of organic silica and/or in the form of a soluble salt. Preferentially, the silicon is in the form of a soluble salt. The term “soluble salt” means a salt that is soluble in a solvent such as water. Silica is an acidic oxide that reacts with basic oxides to give silicates, notably SiO₃²⁻ and SiO₄⁴⁻. Silicates are capable of combining with other metal atoms, such as aluminum (Al), iron (Fe), magnesium (Mg), calcium (Ca), sodium (Na) or potassium (K). The combined silicates thus obtained are, respectively, aluminum silicate (Al₂SiO₃), iron silicate (Fe₂SiO₃), magnesium metasilicate (MgSiO₃), calcium silicate (Ca₂SiO₃), sodium silicate (Na₂SiO₃) and potassium silicate (K₂SiO₃). Silicates may also be in the form of derivatives, for example K₂SiO₄, Na₂SiO₄, Mg₂SiO₄.

Preferably, the silicon is in the form of a soluble salt, preferably in the form of sodium silicate (Na₂SiO₃), potassium silicate (K₂SiO₃), magnesium metasilicate (MgSiO₃) or a mixture of soluble salts. Even more preferentially, the silicon is in the form of a soluble salt chosen from sodium silicate (Na₂SiO₃), potassium silicate (K₂SiO₃), and mixtures thereof. For example, the potassium silicate sold by the company Quaron, called “Liquid potassium silicate 34.8%”, is particularly suitable for use in the invention.

The term “fertilizing material” refers to a substance, or a mixture of substances, which is natural or of synthetic origin, used in agriculture, horticulture and forestry, to improve soils, notably their structure, and to fertilize cultivated plants. Fertilizing materials include fertilizers and soil improvers.

The term “pesticide” refers to a substance used for combating one or more organisms considered to be plant pests, called pathogens. This term notably includes insecticides, fungicides, herbicides and parasiticides.

The term “pesticidal agent” refers to the ability to combat a pathogen, for example by eliminating or repelling said pathogen. This term notably includes insecticidal agents, fungicidal agents, herbicidal agents and parasiticidal agents. In the context of the present invention, it may be a capacity to combat the pathogen directly or indirectly, for example by activating a plant's defense reactions and resistance against biotic stresses. The pathogen is preferentially a fungus, for example an ascomycete fungus, such as Septoria tritici (responsible for septoria) or Venturia inaequalis (responsible for apple scab).

In the context of the present invention, the term “plant” is understood to mean the plant considered as a whole, including its root system, its vegetative system, the seeds and the fruits.

The present invention arises from the surprising advantages demonstrated by the inventors of the effect of the phytosanitary composition according to the invention on a plant, for activating the plant's defense reactions and resistance against biotic stresses.

Thus, the invention relates to a phytosanitary composition comprising:

(i) ulvans and/or ulvan-derived oligosaccharides, for example in the form of an extract containing ulvans and/or ulvan-derived oligosaccharides; and
(ii) silicon.

The composition according to the present invention may be in powder, granule or liquid form, advantageously in liquid form. The preparation of such a composition may be performed by a person skilled in the art using his general knowledge. For example, ulvans and/or ulvan-derived oligosaccharides, for example in the form of an extract containing ulvans and/or ulvan-derived oligosaccharides, may be in powder form or in liquid form and may be mixed with a solution of soluble salt(s) or silicon to form a liquid composition according to the invention. A particular method for preparing the composition according to the invention is detailed in the examples.

When the composition according to the invention is in liquid form, the composition may comprise a concentration of ulvans and/or ulvan-derived oligosaccharides of from 0.01 to 100 g/L, for example from 0.1 g/L to 80 g/L, preferentially from 0.1 g/L to 50 g/L, from 0.1 g/L to 40 g/L, from 0.1 g/L to 30 g/L, even more preferentially from 1 g/L to 20 g/L, from 5 g/L to 15 g/L, for example from 8 g/L to 14 g/L.

When the composition according to the invention is in liquid form, the composition may comprise a silicon concentration of from 0.01 g/L to 100 g/L, in particular in the form of a soluble silicon salt or in the form of a mixture of soluble silicon salts, preferentially from 0.1 g/L to 50 g/L, even more preferentially from 1.0 g/L to 30 g/L, from 10 g/L to 30 g/L, from 20 g/L to 30 g/L, from 5 to 10 g/L, from 5 to 8 g/L, for example about 21 g/L±1 g/L or 6 g/L±1 g/L.

When the composition according to the invention is in liquid form, it may comprise from 10% to 90% (v/v total of the composition) of an extract containing ulvans and/or ulvan-derived oligosaccharides, preferentially from 40% to 90%, for example from 40% to 80%, from 70% to 90% from 70% to 80%, said extract having a concentration of ulvans and/or ulvan-derived oligosaccharides of at least 1 g/L, preferably at least 10 g/L, at least 11 g/L, at least 12 g/L, at least 13 g/L, at least 14 g/L, at least 15 g/L, at least 16 g/L, at least 17 g/L, at least 18 g/L, at least 19 g/L. For example, said extract may have an ulvan and/or ulvan-derived oligosaccharide concentration ranging from 1 to 200 g/L, preferably ranging from 10 to 100 g/L, more preferentially ranging from 15 to 50 g/L, for example an ulvan and/or ulvan-derived oligosaccharide concentration of about 20 g/L±2 g/L.

When the composition according to the invention is in liquid form, it may comprise from 1% to 25% (v/v total of the composition) of a silicon solution, in particular a solution of a soluble silicon salt or a mixture of soluble silicon salts, preferentially from 1% to 10%, for example from 1% to 5%, said silicon solution having a silicon concentration ranging from 0.1 to 500 g/L, preferentially from 1 to 500 g/L, even more preferentially from 10 g/L to 300 g/L, from 100 g/L to 300 g/L, from 200 g/L to 300 g/L, for example about 240 g/L±10 g/L

According to a particular embodiment, a composition according to the invention is in liquid form and comprises:

a concentration of ulvans and/or ulvan-derived oligosaccharides of from 0.01 to 100 g/L, preferentially from 0.1 g/L to 50 g/L, even more preferentially from 1 g/L to 20 g/L, for example from 8 g/L to 14 g/L, and
a silicon concentration of from 0.01 g/L to 100 g/L, in particular in the form of a soluble silicon salt or in the form of a mixture of soluble silicon salts, preferentially from 0.1 g/L to 50 g/L, even more preferentially from 1.0 g/L to 30 g/L, from 10 g/L to 30 g/L, from 20 g/L to 30 g/L, from 5 to 10 g/L, from 5 to 8 g/L, for example about 21 g/L±1 g/L or 6 g/L±1 g/L.

According to another particular embodiment, the composition according to the invention is in liquid form and comprises:
from 10% to 90% (v/v total of the composition) of an extract containing ulvans and/or ulvan-derived oligosaccharides, preferentially from 40% to 90%, for example from 40% to 80%, from 70% to 90%, from 70% to 80%, said extract having a concentration of ulvans and/or ulvan-derived oligosaccharides of at least 1 g/L preferably at least 10 g/L, at least 11 g/L, at least 12 g/L, at least 13 g/L, at least 14 g/L, at least 15 g/L, at least 16 g/L, at least 17 g/L, at least 18 g/L, at least 19 g/L, for example between 1 and 200 g/L, preferably between 10 and 100 g/L, more preferentially between 15 and 50 g/L, for example about 20.0 g/L,
from 1% to 25% (v/v total of the composition) of a silicon solution, in particular a solution of a soluble silicon salt or a mixture of soluble silicon salts, preferentially from 1% to 10%, for example from 1% to 5%, said silicon solution having a silicon concentration ranging from 0.1 to 500 g/L, preferentially from 1 to 500 g/L, even more preferentially from 10 g/L to 300 g/L, from 100 g/L to 300 g/L, from 200 g/L to 300 g/L, for example about 240 g/L±10 g/L, and optionally
water.

According to a preferred embodiment of the invention, the composition is in liquid form and comprises:
40% (v/v total of the composition) of an extract containing ulvans and/or ulvan-derived oligosaccharides, said extract having a concentration of ulvans and/or ulvan-derived oligosaccharides ranging from 8 to 14 g/L,
9% (v/v total composition) of a silicon solution, in particular a solution of a soluble silicon salt or a mixture of soluble silicon salts, said silicon solution having a silicon concentration of about 240 g/L, and
51% of water.

According to another preferred embodiment of the invention, the composition is in liquid form and comprises:
from 70% to 80% (v/v total of the composition) of an extract containing ulvans and/or ulvan-derived oligosaccharides, said extract having a concentration of ulvans and/or ulvan-derived oligosaccharides ranging from 8 to 14 g/L
from 2% to 3% (v/v total composition) of a silicon solution, in particular a solution of a soluble silicon salt or a mixture of soluble silicon salts, said silicon solution having a silicon concentration of about 240 g/L, and
from 17% to 28% of water.

In addition, the composition according to the invention may comprise one or more fertilizing materials, which may be of diverse nature, such as urea, ammonium sulfate, rock phosphate, potassium chloride, ammonium sulfate, magnesium nitrate, manganese nitrate, zinc nitrate, copper nitrate, phosphoric acid, and/or boric acid.

In addition, the composition according to the invention may comprise one or more pesticides, which may be of diverse nature. The pesticide(s) may be chosen from insecticides, fungicides, herbicides and parasiticides. In particular, the composition according to the invention may comprise one or more fungicides. The fungicides that are suitable for use in the invention are, for example, referenced in the “e-phy” catalog of phytopharmaceutical products of the French National Agency for Food, Environmental and Occupational Health Safety (ANSES) or in the “EPPO A1 list” and “EPPO A2 list” catalog of the European and Mediterranean Plant Protection Organization (EPPO). Preferably, the composition according to the invention may comprise one or more fungicides chosen from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole, difenoconazole, propiconazole, tetraconazole, azoxystrobin, picoxystrobin, pyraclostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin. A person skilled in the art will know how to choose the most suitable pesticide(s) for the plant to be treated.

The combination of the composition according to the invention with a pesticide is particularly advantageous since it makes it possible to reduce the doses (or amounts) of pesticide normally used in agriculture. A dose of pesticide normally used corresponds, for example, to a permitted dose for a pesticide under consideration. The combination of the composition according to the invention with a pesticide can make it possible to halve (reduce by 50%) the dose of pesticide normally used. This makes it possible to reduce the impact of phytosanitary products on the environment, which constitutes an ecological and economic advantage.

The invention also relates to the use of the phytosanitary composition described above for activating plant defense reactions and resistance against biotic stresses.

In particular, the invention relates to the use of the phytosanitary composition described above for stimulating the expression of genes involved in the defense of a plant. For example, the phytosanitary composition according to the invention makes it possible to stimulate the expression by the plant of genes coding:
for defense enzymes, such as hydrolases, chitinases;
for “PR” proteins;
for biosynthetic enzymes of defense metabolists, such as phytoalexins;
for proteins involved in parietal reinforcement;
for stimulating the production of salicylic acid and/or derivatives thereof; and/or
for stimulating the production of jasmonic acid and/or derivatives thereof.

Advantageously, the phytosanitary composition of the invention makes it possible to stimulate the expression by the plant of genes coding for salicylic acid and derivatives thereof and/or jasmonic acid and derivatives thereof. In particular, the phytosanitary composition described above makes it possible to stimulate the expression of the ICS1, EDS1 (Disease resistance protein EDS1), WRKY (WRKY transcription factor 30), PR-1 and PR-3 genes, thereby inducing the production of salicylic acid and/or derivatives thereof. In particular, the phytosanitary composition described above is also capable of stimulating the expression of LOX2 (Lipoxygenase); JAR (Jasmonate resistant) genes, thereby inducing the production of jasmonic acid and/or derivatives thereof.

The invention is also directed toward a method for activating plant defense reactions and resistance against biotic stresses, characterized in that it comprises the application to said plant of an effective amount of the phytosanitary composition according to the invention.

The term “effective amount” or “effective dose” means an amount that is sufficient to activate plant defense reactions and resistance, notably by stimulating the expression of genes involved in the defense of the plant, against biotic stresses by at least 5%, advantageously by at least 10%, for example by at least 15%, at least 20%, at least 25%, at least 30%, at least 35%, at least 40%, advantageously by at least 30%. Thus, in a particular embodiment, the composition according to the invention is delivered to the plant in an amount that is sufficient to activate defense reactions of a plant and resistance against biotic stresses, notably by stimulating the expression of genes involved in the defense of the plant, by at least 5%, advantageously by at least 10%, for example by at least 15%, at least 20%, at least 25%, at least 30%, at least 35%, at least 40%, advantageously by at least 30%.

In the use or method according to the invention, the composition may be delivered to the plant by foliar or root application, preferably by foliar application.

In one embodiment of the use according to the invention, the composition according to the invention is delivered to the plant in combination with one or more pesticides, preferentially one or more fungicides. The fungicides that are suitable for use in the invention are, for example, referenced in the “e-phy” catalog of phytopharmaceutical products of the French National Agency for Food, Environmental and Occupational Health Safety (ANSES) or in the “EPPO A1 list” and “EPPO A2 list” catalog of the European and Mediterranean Plant Protection Organization (EPPO). In particular, in one embodiment of the use, the composition according to the invention is delivered to the plant in combination with one or more fungicides, chosen from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole difenoconazole, propiconazole, tetraconazole, azoxystrobin, picoxystrobin, pyraclostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin. A person skilled in the art will know how to choose the most suitable pesticide(s) for the plant to be treated.

The method of the invention may also involve applying to said plant one or more pesticides, preferentially one or more fungicides. The fungicides that are suitable for use in the invention are, for example, referenced in the “e-phy” catalog of phytopharmaceutical products of the French National Agency for Food, Environmental and Occupational Health Safety (ANSES) or in the “EPPO A1 list” and “EPPO A2 list” catalog of the European and Mediterranean Plant Protection Organization (EPPO). In particular, in one embodiment of the method, the composition according to the invention is delivered to the plant in combination with one or more fungicides chosen, for example, from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole difenoconazole, propiconazole, tetraconazole, azoxystrobin, picoxystrobin, pyraclostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin. In other words, the composition according to the invention is also applied to the plant in combination with one or more pesticides, preferentially one or more fungicides. A person skilled in the art will know how to choose the most suitable pesticide(s) for the plant to be treated.

The composition according to the invention and the pesticide(s) may be applied simultaneously or sequentially. For example, the composition according to the invention may be applied in a first treatment, and one or more pesticides may be applied in a second treatment of the plant. Several successive treatments of the plant can thus be performed. Generally, a person skilled in the art adapts the number of treatments and the nature of the treatment according to the variety of the plant, the type of pesticide, the nature of the biotic stress, etc.

When performing the method according to the invention, the amount (or dose) of pesticide applied to the plant may correspond to an amount normally used in agriculture (permitted amount) or to a reduced amount. Advantageously, the pesticide dose is a reduced amount, for example reduced by 50% relative to an amount normally used in agriculture.

The use according to the invention and the method according to the invention are applicable to the treatment of a very wide variety of plants. Among these, mention will be made in particular of:
field crops such as cereals (wheat, corn, barley),
protein crops (peas),
oilseeds crops (soybean, sunflower),
Solanaceae crops (potato),
Amaranthaceae crops (beet),
specialized crops in particular such as in market gardening (lettuce, spinach, onion, shallot, tomato, melon), vineyard, arboriculture (pear, apple, nectarine) or horticulture.

The plant may also belong to the order of monocotyledons, preferably to the Poaceae family. The Poaceae, commonly called gramineae, notably include most of the species commonly called “grasses” and “cereals”. Cereals are widely cultivated, mainly for their grains, and are used in human and animal nutrition. Advantageously, the plant is a Poaceae, preferably chosen from wheat, rice, barley, oats, rye, sugarcane, grassland or corn, preferably wheat.

In the present use and method, the composition according to the invention may be delivered to the plant in liquid form in foliar solutions in an amount ranging from 0.001 to 100 L/ha, preferentially from 0.01 to 25 L/ha, even more preferentially from 0.1 to 10 L/ha, for example in an amount of 1 L/ha. In practice, the farmer generally uses 1 L of a stock solution which corresponds to the composition according to the invention which he dilutes, for example in water to between tenfold and 1000-fold, so as to obtain a daughter solution which is then sprayed on the plants to be treated in the amounts defined above (i.e. from 0.001 to 100 L/ha of stock solution).

In an entirely particular embodiment, the invention relates to the use of the phytosanitary composition according to the invention for activating defense reactions of a plant (for example wheat or apple) and resistance against septoria and/or apple scab.

In a particular embodiment, when the composition according to the invention comprises one or more pesticides, it can be used as a pesticidal agent against a pathogen. This use is particularly advantageous since it allows the dose of pesticide used to be reduced relative to the use of pesticide(s) alone. This makes it possible to reduce the impact of the phytosanitary products on the environment, which constitutes an ecological and economic advantage. Preferably, when the composition according to the invention comprises one or more fungicides, it can be used as a fungicidal agent against a pathogen, for example chosen from Septoria tritici or Venturia inaequalis.

The invention also relates to a method for treating a plant to promote its growth by reducing the access of pathogens to said plant or by eliminating pathogens present in the soil, said method involving applying to said plant a composition according to the invention comprising one or more pesticides. In a particularly preferred embodiment of the method of the invention, the composition according to the invention comprising one or more fungicides is applied to said plant so as to promote the growth of a plant by reducing the access of Septoria tritici or Venturia inaequalis to said plant or by eliminating Septoria tritici or Venturia inaequalis present in the soil.

The invention also relates to the use of the composition according to the invention for potentiating the pesticidal effect of a pesticide. Preferably, the composition according to the invention is used for potentiating the fungicidal effect of a fungicide which may be chosen from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole, difenoconazole propiconazole, tetraconazole, azoxystrobin, picoxystrobin, pyradostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin. In a particularly preferred embodiment, the pesticide is a fungicide chosen from chlorothalonil, fluxapyroxad, epoxiconazole, captan and dithlanon.

The present invention will now be illustrated with the aid of the nonlimiting examples that follow. In these examples, and unless otherwise indicated, the percentages are expressed on a weight basis and the temperature is room temperature.

### Examples

### Example 1: Method for Preparing a Composition According to the Invention

A) Method for Preparing an Ulvan Extract.

The ulvan extract was prepared in a three-step method:

Step 1: 50 kg of dry Ulva spp. algae were ground and passed through a 4 mm sieve to obtain fragments less than or equal to 4 mm, then mixed with 950 kg of water heated to 85° C. The mixture was maintained at a temperature of 85° C. for 3 hours with stirring which allowed the ulvans to be extracted.

Step 2: The mixture obtained in step 1 was filtered through a 50 μm filter.

Step 3: The filtered mixture was then acidified to pH 3.5 using concentrated sulfuric acid solution. This mixture corresponds to the ulvan extract used in the examples, and which is notably used for the preparation of the “ND” composition (composition according to the invention—Example 1C).

B) Method for Preparing a Silicon Solution

A solution of silicon in the form of potassium silicate, sold by the company Quaron under the name Liquid potassium silicate 34.8%, was used. This solution contains 24% w/w of SiO₂ (24% w/w, i.e. 240 g/L of silicon) and 11% w/w of K₂O.

C) Method for Preparing a Phytosanitary Composition According to the Invention, Referred to Hereinbelow as “ND” Composition

The ND composition (composition according to the invention) was prepared by mixing the extract obtained according to the method described in Example 1A with water, adjusting the pH of the mixture to 12, and slowly adding the silicon solution obtained in Example 1B with vigorous stirring, according to the proportions presented in Table 1.

TABLE 1

| | Amount (in % v/v |
|---|---|
| | relative to the total |
| Ingredient of the “ND” composition | volume of the composition) |
| Ulvan extract obtained in Example 1A | 40% |
| Silicon solution (potassium silicate | 9% |
| (SiO₂, K₂O)) obtained | |
| in Example 1B | |
| Water | 51% |

The “ND” composition comprises 8 g/L of ulvans and 21.6 g/L of silicon.

### Example 2: Demonstration of the Effects of the ND Composition on Controlling the Development of Septoria on Wheat

A) Experimental Protocol

The test was conducted in the open field to evaluate the efficiency of the ND composition (obtained in Example 1) against septoria in wheat. The wheat variety CAPO (Triticum aestivum), which is a soft winter wheat susceptible to septoria, was chosen. The pathogen involved in the septoria disease, a fungal disease, is Septoria tritici.

Wheats were sown at a depth of 2 cm and at a sowing density of 230 plants/m². The experimental design was a Fisher block design with four completely randomized replications in the field. The wheat, grown in the open field, was naturally infested with septoria. Septoria tritici is generally spread in wheat crops by ambient moisture or rain. The spores spread to the upper leaves from the base to the top of the plant.

For this test, three foliar treatments were tested:
a negative control, which received no treatment (untreated control, NT Control),
a program called “50% ND Composition”, which consisted in applying the ND composition at a time T₁ at a dose of 0.5 L/ha, followed by a second application of the ND composition at a time T₂ in the same amount as the dose applied at T₁,
a program called “100% ND Composition”, which consisted in applying the ND composition at a time T₁ at a dose of 1 L/ha, followed by a second application of the ND composition at a time T₂ at the same dose as the dose applied at T₁.

The three treatments are summarized in Table 2 below:

TABLE 2

| | Time T₁ | Time T₂ |
|---|---|---|
| | (Stage 31, called | (Stage 39, called |
| | BBCH31) | BBCH39) |
| Negative | No treatment | No treatment |
| control | | |
| “50% ND | 0.5 L/ha | 0.5 L/ha |
| Composition” | | |
| program | | |
| “100% ND | 1 L/ha | 1 L/ha |
| Composition” | | |
| program | | |

The ND composition was applied once at the first node stage, i.e. at the stage known as “stage 31”, corresponding to the elongation of the main stem (phenological stage BBCH31, i.e. the first node is at most 1 cm above the tillering plateau), and then once at the phenological stage BBCH39 (at this stage, the blade of the last leaf is fully unfolded, the ligule is visible).

25 wheat samples were observed for each of the three treatment types. Septoria is a foliar disease with characteristic symptoms of brown spots in which are observed black dots, called “pycnidia”. The presence of septoria on the samples was observed by analyzing the presence of spots and/or black dots on the F0 and F1 leaves at the wheat developmental stage known as “stage 75” corresponding to the medium milk stage (milky seed content). Indeed, the F0 and F1 leaves contribute very largely to the yield at the end of growing the crop and the phytosanitary treatments against septoria are mainly aimed at protecting these two leaves from the appearance and development of septoria (FIG. 1). Septoria severity represents the level of manifestation of septoria symptoms, such as presence of spots, presence of pycnidia, spread of spots and pycnidia on a single observed leaf. This severity is taken into account predominantly in the evaluation of the presence and development of septoria. The frequency represents the number of infected samples relative to the total number of samples observed (in this case 25 samples). The severity was measured according to the EPPO (European and Mediterranean Plant Protection Organization) standards No. PP 1/26(4) called “Leaf and ear diseases of cereals”.

B) Results

The results obtained are shown in FIGS. 2A and 2B. They show that in the absence of treatment (NT Control), septoria developed on the wheat. In the absence of treatment (NT Control), the F0 and F1 leaves were infected to 25% and 55%, respectively, in terms of severity, and to 100% in terms of frequency.

Treatment with the 50% ND composition reduced the severity of septoria on the F0 and F1 leaves to 14% and 33%, respectively, in terms of severity (compared to 25% and 55% observed in the NT control). The frequency was not impacted (100% infected leaves) after treatment with the 50% ND composition.

Treatment with the 100% ND composition reduced the severity of septoria on the F0 and F1 leaves to 10.5% and 25.5%, respectively, in terms of severity (compared to 25% and 55% in the NT control, and compared to 14% and 33% observed after the “50% ND” treatment). The frequency of septoria was not impacted (100% infected leaves) after treatment with the 100% ND composition.

The results show that the ND composition alone (composition according to the invention) significantly protects the wheat plants against septoria of wheat.

### Example 3: Demonstration of the Effects of the ND Composition in Combination with a Fungicide

A) Experimental Protocol

The test was conducted in the open field to evaluate the efficiency of the ND composition (composition according to the invention, obtained in Example 1) in combination with a fungicide (chlorothalonil-based preparation). The wheat variety chosen to conduct this test was the Oregrain variety, a soft winter wheat variety (Triticum aestivum), which is susceptible to septoria as explained in Example 2.

The wheat was sown at a depth of 2 cm and at a sowing density of 250 plants/m². The experimental design in the plot was a Fisher block design with four completely randomized replications in the field. The wheat, grown in the open field, was naturally infested with septoria.

For this test, five foliar treatments were tested:
a negative control, which consisted in applying no treatment (NT Control);
a program called “Classic Fungicide” or “Fungi. Pr.” (positive control), which corresponds to a program commonly implemented by those skilled in the art, which consisted in applying a first fungicidal treatment (chlorothalonil at its permitted dose, i.e. 500 g/ha) at a time T₁, and applying a second fungicidal treatment (combination of epoxiconazole and fluxapyroxad at their permitted doses, i.e. 62.5 g/ha each) at a time T₂;
   a program called “Lite Fungicide” or “Lite Fungi. Pr.” (plausibility control) which consisted in applying chlorothalonil at 250 g/ha at a time T₁, and applying a second fungicidal treatment (combination of epoxiconazole and fluxapyroxad at half their permitted doses, i.e. 31.25 g/ha each) at a time T₂;
   a program called “50% ND Composition+Lite Fungi. Pr.” which consisted of a first application of 0.5 L/ha of the ND composition (composition obtained in Example 1) in combination with chlorothalonil at half its permitted dose, i.e. 250 g/ha, at time T₁, and a second application of a fungicidal treatment (combination of epoxiconazole and fluxapyroxad at half their permitted doses, i.e. 31.25 g/ha each) at time T₂;
a program called “100% ND Composition+Lite Fungi. Pr.” which consisted of a first application of 1 L/ha of the ND Composition (the composition obtained in Example 1) in combination with chlorothalonil at half its permitted dose, i.e. 250 g/ha, at time T₁, and a second application of a fungicidal treatment (a combination of epoxiconazole and fluxapyroxad at half their permitted doses, i.e. 31.25 g/ha each) at time T₂.

Time T₁ corresponds to stage 31, i.e. the first node stage, corresponding to main stem elongation (phenological stage BBCH31, i.e. the first node is at most 1 cm above the tillering plateau), and time T₂ corresponds to stage 33, called BBCH33, corresponding to a main stem elongation more than 2 cm above the second node.

The five treatment types are summarized in Table 3 below:

TABLE 3

| | Time T₁ | Time T₂ |
|---|---|---|
| | (Stage 31, called | (Stage 33, called |
| Program | BBCH31) | BBCH33) |
| Negative | No treatment | No treatment |
| control | | |
| Fungi. Pr. | 500 g/ha of | 62.5 g/ha of epoxiconazole + |
| | chlorothalonil | 62.5 g/ha of fluxapyroxad |
| Lite Fungi. | 250 g/ha of | 31.25 g/ha of epoxiconazole + |
| Pr. | chlorothalonil | 31.25 g/ha of fluxapyroxad |
| 50% ND | 0.5 L/ha of the ND | 31.25 g/ha of epoxiconazole + |
| Composition + | composition + | 31.25 g/ha of fluxapyroxad |
| Lite Fungi. Pr. | 250 g/ha of | |
| | chlorothalonil | |
| 100% ND | 1 L/ha of the ND | 31.25 g/ha of epoxiconazole + |
| Composition + | composition + | 31.25 g/ha of fluxapyroxad |
| Lite Fungi. Pr. | 250 g/ha of | |
| | chlorothalonil | |

25 wheat samples were observed for each treatment type. The presence of septoria on the samples was observed by observing the frequency and severity of septoria (see Example 2) on the F0 and F1 leaves at the stage known as stage 75, corresponding to the medium milk stage (milky seed content).

B) Results

The results obtained are shown in FIGS. 3A and 3B.

They show that in the absence of treatment (NT Control), septoria developed on the wheat. In the absence of treatment (NT Control), the F0 and F1 leaves were infected to 25% and 55%, respectively, in terms of severity, and to 100% in terms of frequency for the F0 and F1 leaves.

The treatment with the Fungi. Pr. (Positive Control) reduced the severity of septoria on the F0 and F1 leaves to 3% and 5%, respectively, in terms of severity (compared to 25% and 55% observed in the NT control). The frequency of septoria was also reduced to 55% and 82%, respectively, for the F0 and F1 leaves, compared to the 100% frequency observed with the NT control.

The treatment with the Lite Fungi. Pr. (Plausibility Control) reduced the severity of septoria on the F0 and F1 leaves to 4.5% and 12.5%, respectively, in terms of severity (compared to 25% and 55% observed in the untreated control). The frequency of septoria was reduced to 90% for the F0 leaf alone, compared to the 100% frequency observed in the untreated control. The frequency of septoria on the F1 leaf remained unchanged (100%).

The application of the ND composition at 0.5 L/ha, in combination with the Lite Fungi. Pr. reduced the severity of septoria on the F0 and F1 leaves to 3.5% and 9.5%, respectively, in terms of severity (compared to 25% and 55% observed in the untreated control, and to 4.5% and 12.5% observed following the Lite Fungi. Pr.). The combination also reduced the frequency of septoria on the F0 leaf to 80% (compared to 100% in the NT control and 90% observed following the Lite Fungi. Pr. treatment). The frequency of septoria on the F1 leaf remained unchanged (100%).

Finally, applying the ND composition at 1 L/ha, in combination with the Lite Fungi. Pr. further reduced the severity of septoria on the F0 and F1 leaves to 2.5% and 7.5%, respectively, in terms of severity (compared to 25% and 55% observed in the untreated control, and to 4.5% and 12.5% observed following the Lite Fungi. Pr. treatment). This combination also further reduced the frequency of septoria on the F0 leaf to 75% (compared to 100% observed in the NT control and to 90% observed following the Lite Fungi. Pr. treatment). The frequency of septoria on the F1 leaf remained unchanged (100%).

It may thus be concluded that the ND composition, when combined with a fungicide (Lite Fungi. Pr.), gives the treated wheat plants better protection against wheat septoria than the fungicide alone. The ND composition potentiated the phytosanitary effect of the fungicide.

### Example 4: Demonstration of the Effects of a Composition According to the Invention in Comparison with an Ulvan Extract or a Silicon Solution Applied Individually

A) Experimental Protocol

The test was conducted in the open field to evaluate the efficiency of a composition according to the invention (ND) in comparison with an ulvan extract at a concentration of 8 g/L alone or a silicon solution alone (SiO₂ K₂O) at a concentration of 21.6 g/L. The wheat variety chosen to conduct this test was the Oregrain variety, a soft winter wheat variety (Triticum aestivum), which is susceptible to septoria.

The wheat was sown at a depth of 2 cm and at a sowing density of 250 plants/m². The experimental design in the plot was a Fisher block design with four completely randomized replications in the field. The wheat, grown in the open field, was naturally infested with septoria.

For this test, six treatments were tested in foliar application:
a negative control, which consisted in applying no treatment (NT Control);
a program called “Classic Fungicide” or “Fungi. Pr.” (positive control which corresponds to a treatment commonly implemented by those skilled in the art) which consisted of a first application of a fungicide, chlorothalonil, at its permitted dose, i.e. 500 g/ha, at time T₁, and a second application of chlorothalonil at 500 g/ha also at time T₂;
a program called “Lite Fungicide” or “Lite Fungi. Pr.” (plausibility control) which consisted of a first application of chlorothalonil at half its permitted dose, i.e. 250 g/ha, at time T₁, and a second application of chlorothalonil at 250 g/ha also at time T₂;
a program called “ND Composition+Lite Fungi. Pr.”, which consisted of a first application of a dose of the ND composition at 1 L/ha in combination with chlorothalonil at half its permitted dose, i.e. 250 g/ha, at time T₁, and a second application of a dose of the ND composition at 1 L/ha in combination with chlorothalonil at half its permitted dose, i.e. 250 g/ha, at time T₂;
a program called “Ulvan Composition 8 g/L+Lite Fungi. Pr.”, which consisted of a first application of a dose of 1 L/ha of the ulvan extract at a concentration of 8 g/L (i.e. the ND composition without silicon) in combination with chlorothalonil at half its permitted dose, i.e. 250 g/ha, at time T₁, and a second application of a dose of 1 L/ha of the ulvan extract at a concentration of 8 g/L in combination with chlorothalonil at half its permitted dose, i.e. 250 g/ha, at time T₂; and
a program called “Silicon Composition 21.6 g/L+Lite Fungi. Pr.”, which consisted of a first application of a dose of 1 L/ha of 902 K₂O solution at a concentration of 21.6 g/L of silicon (i.e. the ND composition without the ulvan extract) in combination with chlorothalonil at half its permitted dose, i.e. 250 g/ha, at time T₁, and a second application of a dose of 1 L/ha of 902 K₂O solution at a concentration of 21.6 g/L of silicon in combination with chlorothalonil at half its permitted dose, i.e. 250 g/ha, at time T₂.

Time T₁ corresponds to stage 31, i.e. the first node stage, corresponding to main stem elongation (phenological stage BBCH31, i.e. the first node is at most 1 cm above the tillering plateau), and time T₂ corresponds to stage 33, called BBCH33, corresponding to a main stem elongation more than 2 cm above the second node. The six treatments are summarized in Table 4.

TABLE 4

| | Time T₁ | Time T₂ |
|---|---|---|
| | (Stage 31, called | (Stage 33, called |
| | BBCH31) | BBCH33) |
| Negative | No treatment | No treatment |
| control | | |
| “Fungi. | 500 g/ha of | 62.5 g/ha of epoxiconazole + |
| Pr.” | chlorothalonil | 62.5 g/ha of fluxapyroxad |
| “Lite Fungi. | 250 g/ha of | 31.25 g/ha of epoxiconazole + |
| Pr.” | chlorothalonil | 31.25 g/ha of fluxapyroxad |
| “ND + Lite | 1 L/ha of the ND | 31.25 g/ha of epoxiconazole + |
| Fungi. Pr.” | composition + | 31.25 g/ha of fluxapyroxad |
| Composition | 250 g/ha of | |
| | chlorothalonil | |
| “Ulvan 8 | 1 L/ha of the ulvan | 1 L/ha of the ulvan |
| g/L + Lite | extract + 250 g/ha | extract + |
| Fungi. Pr.” | of chlorothalonil | 250 g/ha of chlorothalonil |
| Composition | | |
| “Silicon 21.6 | 1 L/ha of the silicon | 1 L/ha of the silicon |
| g/L + Lite | solution + 250 g/ha | solution + |
| Fungi. Pr.” | of chlorothalonil | 250 g/ha of chlorothalonil |
| Composition | | |

The treatments were applied once (T₁) at the first node stage, which is the stage known as stage 31 corresponding to main stem elongation (phenological stage BBCH31, i.e. the first node is at most 1 cm above the tillering plateau), and then applied again (T₂) at the third node stage, which is the stage known as BBCH33, corresponding to main stem elongation more than 2 cm above the second node.

25 wheat samples were observed for each treatment type. The presence of septoria on the samples was observed by observing the frequency and severity of septoria (see Example 2) on the F0 leaf at the stage known as stage 85 corresponding to seed maturation, more particularly the soft pasty stage, when the seed content is tender and dry (BBCH85 stage).

B) Results

The results obtained are given in FIG. 4.

They show that in the absence of treatment (NT Control), septoria developed on wheat that was grown in the open field. The F0 leaf was infected (70% in terms of severity; 100% in terms of frequency).

The fungicidal program (Fungi. Pr.) reduced the severity of septoria on the F0 leaf of the observed plants in terms of severity (40%) but not the frequency of the disease (100%).

The Lite Fungicide Program (Lite Fungi Pr.) reduced septoria on the F0 leaf of the observed plants in terms of severity, to a lesser extent than the Fungi. Pr. (50% instead of 40% with the Fungi. Pr.) but not the frequency of the disease (100%).

For the ND composition applied in combination in a Lite Fungi Pr., it was observed that the F0 leaf was less infected than the F0 leaf of control plants (40%). The F0 leaf was also better protected than the one treated with the lite fungicide program and showed a level of protection against septoria close to that obtained with the Fungi. Pr.

Finally, the treatments with the ulvan extract and with silicon solution afforded a lower level of protection than the ND composition. Indeed, it is observed that with the “Ulvans 8 g/L+Lite Fungi Pr.” or “Silicon 21.6 g/L+Lite Fungi Pr.” treatment, the severity was 47% and 52%, respectively, compared to 50% for the lite fungicide program. The ND composition, for its part, significantly decreased the severity (40%).

It may thus be concluded that the ND composition has better efficiency, relative to the ulvan extract alone, to the silicon solution alone or even relative to a lite fungicide program.

### Example 5: Study of the Expression of Defense Genes in Treated Wheat after Treatment with the ND Composition

A) Experimental Protocol

The study was performed in an experimental greenhouse. Young wheat seedlings 28 days old were treated with the following treatments by foliar spraying at the third unfolded leaf stage (BBCH13 stage):
the ND composition of Example 1 diluted 400-fold (v/v),
the ND composition of Example 1 diluted 100-fold (v/v),
a commercial product called Bion® 50 WG, sold by Syngenta, containing 50% benzolar-S-methyl acid, concentrated to 20 μg/ml. Bion® 50 WG is a plant defense stimulator (PDS), referred to hereinbelow as “PDS control” (positive control),
distilled water (negative control).

The third unfolded leaf was used for gene expression analyses by quantitative RT-PCR, 48 hours after treatment.

B) Results

The results obtained are given in FIG. 5.

They show that treatment of the wheat leaves with the composition according to the invention at 400-fold and 100-fold dilutions significantly activated the expression of the ICS1, PR-1 and PR-3 genes, three marker genes for the induction/activation of the plant defense mechanisms, in particular the salicylic acid activation pathway, in comparison with the NT control. The PDS control (Bion®), a positive control, also shows an increase in the expression of these genes.

It may thus be concluded that the ND composition makes it possible to activate the plant defense reactions and resistance against biotic stresses.

### Example 6: Demonstration of the Effects of the ND Composition on Controlling the Development of Apple Scab

A) Experimental Protocol

The agronomic efficiency tests on apple scab by natural contamination were performed during the primary contamination phase; over a period from March to June. Apple scab is caused by an ascomycete fungus called Venturia inaequalis which causes black or brown lesions on the surface of apple leaves, buds or fruits and sometimes even on the wood. The fruit and the underside of the leaves are especially susceptible. The disease is favored by a humid climate, notably when the buds are developing (bud break). Apple scab can significantly reduce fruit quality and production if left untreated.

Trees of the Golden Delicious variety (Reinders clone, twelfth leaf) grafted on M9-Emla rootstock, varieties that are highly susceptible to apple scab, were used. For this test, four types of foliar spray treatments were compared:
a “Classic Fungicide” program (called “IFP”), which consisted in applying fungicides in Integrated Fruit Production (IFP) at seven different times and alternating the types of fungicide, as summarized in Table 5 below;
a program called “Lite Fungicide” (called “Lite IFP”), which consisted in applying fungicides in Integrated Fruit Production (IFP) at three different times and alternating the types of fungicide, as summarized in Table 5 below,
a program called “Lite Fungicide+Bion® 50 WG” or “Lite IFP+Bion® 50 WG”, which consisted in applying the Bion®50 WG product described in Example 5 at nine different times and fungicides at three different times, as summarized in Table 5 below, and
a program called “Lite Fungicide+ND Composition” or “Lite IFP+ND Composition”, which consisted in applying the ND Composition (obtained in Example 1) at a dose of 3 L/ha at nine different times and fungicides at three different times, as summarized in Table 5 below.

The different times correspond to apple tree developmental stages and are listed in Table 5 below.

TABLE 5

| | | | Lite IFP + Bion | Lite IFP + ND |
|---|---|---|---|---|
| | | | 50 WG ® | Composition |
| | IFP | Lite IFP | 150 g/ha | 3 L/ha |
| Time T₁ | 1.9 kg/ha of | 1.9 kg/ha of | 1.9 kg/ha of | 1.9 kg/ha of |
| BBCH53 | Captan at a | Captan at a | Captan at a | Captan at 800 |
| | concentration | concentration | concentration of | g/kg + ND |
| | of 800 g/kg | of 800 g/kg | 800 g/kg + | Composition 3 |
| | | | Bion 50 WG ® | L/ha |
| | | | at a dose of 150 | |
| | | | g/ha | |
| Time T₂ | No treatment | No treatment | Bion 50 WG ® at | ND Composition |
| BBCH55 | | | a dose of 150 | 3 L/ha |
| | | | g/ha | |
| Time T₃ | 0.5 kg/ha of | 0.5 kg/ha of | 0.5 kg/ha of | 0.5 kg/ha of |
| BBCH57 | diathianon at a | diathianon at a | diathianon at a | diathianon at a |
| | concentration | concentration | concentration of | concentration of |
| | of 700 g/kg | of 700 g/kg | 700 g/kg + Bion | 700 g/kg + ND |
| | | | 150 g/ha | Composition at a |
| | | | | dose of 3 L/ha |
| Time T₄ | No treatment | No treatment | Bion 50 WG ® at | ND Composition |
| BBCH59 | | | a dose of 150 | at a dose of 3 |
| | | | g/ha | L/ha |
| Time T₅ | No treatment | No treatment | Bion 50 WG ® at | ND Composition |
| BBCH60 | | | a dose of 150 | at a dose of 3 |
| | | | g/ha | L/ha |
| Time T₆ | 67 g/ha of | No treatment | No treatment | No treatment |
| BBCH61 | pyraclostribine | | | |
| | and 267 g/ha | | | |
| | of Boscalid | | | |
| Time T₇ | 1.7 L/ha of | No treatment | No treatment | No treatment |
| BBCH63 | dodine at a | | | |
| | concentration | | | |
| | of 544 g/L | | | |
| Time T₈ | No treatment | No treatment | Bion 50 WG ® at | ND Composition |
| BBCH65 | | | a dose of 150 | at a dose of 3 |
| | | | g/ha | L/ha |
| Time T₉ | No treatment | No treatment | Bion 50 WG ® at | ND Composition |
| BBCH67 | | | a dose of 150 | at a dose of 3 |
| | | | g/ha | L/ha |
| Time T₁₀ | 1.9 kg/ha of | | No treatment | No treatment |
| BBCH69 | Captan at a | | | |
| | concentration | | | |
| | of 800 g/kg | | | |
| Time T₁₁ | 2 L/ha of | 2 L/ha of | 2 L/ha of | 2 L/ha of |
| BBCH71 | Fenbuconazole | Fenbuconazole | Fenbuconazole | Fenbuconazole |
| | at a | at a | at a | at a |
| | concentration | concentration | concentration of | concentration of |
| | of 25 g/L | of 25 g/L | 25 g/L + Bion | 25 g/L + ND |
| | | | 50 WG ® at a | Composition at a |
| | | | dose of 150 | dose of 3 L/ha |
| | | | g/ha | |
| Time T₁₂ | No treatment | No treatment | Bion 50 WG ® at | ND Composition |
| BBCH73 | | | a dose of 150 | at a dose of 3 |
| | | | g/ha | L/ha |
| Time T₁₃ | 2 L/ha of | No treatment | No treatment | No treatment |
| BBCH75 | Captan at a | | | |
| | concentration | | | |
| | of 800 g/kg | | | |
| Total | 7 fungicidal | 3 fungicidal | 3 fungicidal | 3 fungicidal |
| | treatments | treatments | treatments and | treatments and |
| | | | 9 treatments | 9 treatments |
| | | | with Bion 50 | with ND |
| | | | WG ® | Composition 3 |
| | | | 150 g/ha | L/ha |

Each treatment was applied on three microplots represented by a factorial design of three blocks of three microplots, each microplot consisting of five rows of thirteen trees (i.e. 195 treated trees). The apples were then harvested in September.

B) Results

The percentage of scabbed fruit was calculated for each plot. The scabbed fruit is characterized by spots and may crack.

The results obtained are given in FIG. 6.

They show that the classic IFP fungicide program afforded optimum protection of the crop, and was reflected by a crop of apples with very little scab, or even no scab at all.

The “lite IFP” program afforded only partial protection of the orchard, with more than 30% of the apples scabbed at the time of harvest.

The “lite IFP+ND composition” program afforded improved orchard protection, relative to the lite IFP, with less than 20% of the apples scabbed at the time of harvest.

Finally, it was observed that the “lite IFP+ND Composition” program afforded a higher level of orchard protection than the “lite IFP+Bion® 50 WG” program.

### Example 7: Demonstration of the Effects of the ND Composition on Apple Crop Quality

A) Experimental Protocol

400 apples (100 apples per treatment type: IFP, lite IFP, lite IFP+Bion 50 WG, and lite IFP+ND composition), randomly sampled, harvested following the test in Example 6, were graded as a function of their visual appearance. If no scab was present, the fruit was considered healthy. When a fruit had one to three spots, it was considered to have low scab presence (called low-scabbed fruit). When a fruit had more than three spots, it was considered to have a high presence of scab (called severely scabbed fruit).

B) Results

The results obtained are given in FIG. 7.

They showed that the reference program (IFP) had optimum efficiency against apple scab since all the observed fruits were healthy.

The “lite IFP” program showed impairment of the visual quality of the apples with nearly 40% of the apples scabbed, of which 10% were severely scabbed.

The “lite IFP+ND composition” program reduced the percentage of scabbed apples to 20% with less than 3% of severely scabbed apples. Thus, the ND composition efficiently protects the apples.

Finally, it was observed that the “lite IFP+ND composition” program afforded a higher level of protection than the “lite IFP+Bion® 50 WG” program.

### Example 8: Demonstration of the Effects of the ND Composition on Stimulating the Defense Reactions in Apple Trees

A) Experimental Protocol

Apple seedlings of the Golden Delicious variety (6 weeks old) grown in a greenhouse and showing developed leaves were treated by foliar spraying until runoff with
the ND composition (obtained in Example 1) diluted 200-fold (v/v),
the ND composition of Example 1 diluted 66-fold (v/v).

The seedlings were treated twice (on D-3 and on D-1) before taking plant samples.

The treated leaves were sampled 1 day (D1) and 3 days (D3) post-treatment. The samples were used for analysis of the level of expression of the apple defense genes (analysis performed by quantitative RT-PCR). The list of the apple genes that were analyzed is presented in Table 6 below. The results were expressed as log 2 of the sum of the induced defense genes, after normalization relative to a control (control: treatment of the seedlings with water). This analysis allowed a precise measurement of the effect of the ND composition application on the expression of several apple defense genes, these genes being described in the literature for activating the plant defense reactions.

TABLE 6

| Classes and subclasses | |
|---|---|
| of defense: Chemical | |
| and/or physical | |
| barriers | Gene names |
| PR Proteins | PR-1 Pathogenesis-related protein 1; PR-2 |
| | Pathogenesis-related protein 2 (glucanases); PR-4 |
| | Pathogenesis-related protein 4 (hevein-like); PR-5 |
| | Pathogenesis-related protein 5 (thaumatin-like, |
| | osmotin); PR-8 Pathogenesis-related protein 8 |
| | (class III chitinase); PR-14 Pathogenesis-related |
| | protein 14 (lipid transfer protein); PR-10 |
| | Pathogenesis-related protein 10 (β- glucuronidase) |
| Phenylpropanoid | PAL Phenylalanine ammonia-lyase; CHS |
| pathway | Chalcone synthase; DFR Dihydroflavonol |
| | reductase; BIS2 Biphenyl synthase; PPO |
| | Polyphenol oxidase |
| Isoprenoid pathway | HMGR Hydroxymethyl glutarate-CoA reductase; |
| | FPPS Farnesyl pyrophosphate synthase; Far |
| | (E,E)-alpha-farnesene synthase |
| Cysteine pathway | CSL Cysteine lyase |
| Oxidative stress | APOX Ascorbate peroxidase; GST Glutathione |
| | S-transferase; POX Peroxidase; |
| Parietal modifications | CalS Callose synthase; Pect Pectin methyl |
| | esterase; CAD Cinnamyl alcool dehydrogenase |
| Lectin pathway | AGL Agglutinin |
| Hormonal signaling: | EDS1 Disease resistance protein EDS1, WRKY |
| salicylic acid pathway | WRKY transcription factor 30 |
| Hormonal signaling: | LOX2 Lipoxygenase; JAR Jasmonate resistant 1 |
| jasmonic acid pathway | |
| Ethylene pathway | ACCO 1-aminocyclopropene-1-carboxylate |
| | oxidase; EIN3 EIN 3-BINDING F BOX |
| | PROTEIN 1 |

B) Results

The results obtained are presented in FIG. 8 and show that the ND composition globally activated the apple defense genes.

### Example 9: Demonstration of the Effects of the ND Composition on Certain Defense Genes, Very Specific Markers of Defense Reactions in Apple Trees

Apple seedlings of the Golden Delicious variety (6 weeks old) grown under greenhouse conditions and showing developed leaves were treated with:
the ND composition of Example 1 diluted 200-fold (v/v) or
the ND composition of Example 1 diluted 66-fold (v/v).
The seedlings were treated once at 6 weeks by foliar spraying. A portion of the seedlings was treated with water (H₂O Control).

The experimental protocol is identical to that presented in Example 8. The expression of a selection of genes, described in the literature as markers of plant defense activation, was measured.

The PR (Pathogenesis-Related) gene cluster 1 to 14 is regularly used in the literature as markers of plant defense activation.

Treated leaves were sampled 1 day (D1) post-treatment. The obtained samples were used for quantitative RT-PCR analysis. The results are expressed in log 2. This analysis accurately measured the effect of the ND composition application on the expression of several PR genes.

B) Results

The results obtained are presented in FIG. 9 and show that treatment of the apple seedlings with the ND composition activated the expression of the PR-1, PR-5, PR-8, PR-14 and PR-10 genes. For most of the PR genes, a dose-dependent increase in the level of expression was observed.

These results confirm that the ND composition activates plant defense reactions, in particular stimulates the expression of the plant defense genes.

### BRIEF DESCRIPTION OF THE DRAWINGS

FIG. 1 illustrates the numbering of wheat leaves F0, F1, F2, F3, F4.

FIG. 2A represents the severity of septoria (left-hand figure) on the F0 wheat leaves at stage 75 of wheat development and the frequency of septoria (right-hand figure) observed on the F0 wheat leaves at stage 75 of wheat development, for wheat plants which received no fungicidal treatment (NT Control), wheat plants which were treated with the ND composition at 50% of its effective dose, i.e. 0.5 L/ha, and wheat plants which were treated with the ND composition at 100% of its effective dose, i.e. 1 L/ha.

FIG. 2B represents the severity of septoria (left-hand figure) on the F1 wheat leaves at stage 75 of wheat development and the frequency of septoria (right-hand figure) observed on the F1 wheat leaves at stage 75 of wheat development, for wheat plants which received no fungicidal treatment (NT Control), wheat plants which were treated with the ND composition at 50% of its effective dose, i.e. 0.5 L/ha, and wheat plants which were treated with the ND composition at 100% of its effective dose, i.e. 1 L/ha.

FIG. 3A represents the severity of septoria (left-hand figure) and the frequency of septoria (right-hand figure) observed on the F0 wheat leaves, for wheat plants which received no fungicidal treatment (NT Control), wheat plants which were treated with a fungicide program (Fungi. Pr.), wheat plants which were treated with a lite fungicide program (lite Fungi. Pr.), wheat plants which were treated with an ND composition program applied at 50% of its effective dose, i.e. 0.5 L/ha in combination with the lite Fungi. Pr., and wheat plants which were treated with an ND composition program applied at 100% of its effective dose, i.e. 1 L/ha in combination with the lite Fungi. Pr.

FIG. 3B represents the severity of septoria (left-hand figure) and the frequency of septoria (right-hand figure) observed on the F1 wheat leaves, for wheat plants which received no fungicidal treatment (NT Control), wheat plants which were treated with a fungicide program (Fungi. Pr.), wheat plants which were treated with a lite fungicide program (lite Fungi. Pr.), wheat plants which were treated with an ND composition program applied at 50% of its effective dose, i.e. 0.5 L/ha in combination with the lite Fungi. Pr., and wheat plants which were treated with an ND composition program applied at 100% of its effective dose, i.e. 1 L/ha in combination with the lite Fungi. Pr.

FIG. 4 represents the severity of septoria (left-hand figure) and the frequency of septoria (right-hand figure) observed on the F0 wheat leaves, for wheat plants which received no fungicidal treatment (NT Control), wheat plants which were treated with a classic fungicide program (Fungi. Pr.), wheat plants which were treated with a lite fungicide program (lite Fungi. Pr.), wheat plants which were treated with an ND composition program applied at its effective dose (i.e. 1 L/ha) in combination with the lite Fungi. Pr. (ND+lite Fungi. Pr.), wheat plants which were treated with an 8 g/L “ulvan extract” program applied in combination with the lite Fungi. Pr. (ulvan extract+lite Fungi. Pr.), and wheat plants which were treated with a 21.6 g/L “silicon solution” program applied in combination with the lite Fungi. Pr. (Silicon+lite Fungi. Pr.).

FIG. 5 shows the level of expression of the ICS1 gene, the PR-1 gene and the PR-3 gene in wheat leaves at the BBCH13 stage (3rd leaf unfolded) measured by quantitative RT-PCR, for wheat plants which received no treatment (NT Control), wheat plants which were treated with a positive control (commercial product Bion® 50 WG), wheat plants which were treated with the ND composition diluted 400-fold (v/v) and wheat plants which were treated with the ND composition diluted 100-fold (v/v).

FIG. 6 shows the percentage of scabbed fruit, obtained on Golden Delicious apple trees, for apple trees which were treated with a reference program called Integrated Fruit Production (IFP), a lite fungicide program (lite IFP), a lite IFP+Bion® 50 WG program, or a lite IFP+ND composition program.

FIG. 7 shows the percentage of healthy, lightly scabbed and severely scabbed fruit for apple trees which received a fungicidal treatment in a conventional integrated fruit production (IFP) program, apple trees which received a lite treatment (lite IFP), apple trees which received a lite treatment+Bion® 50 WG, or apple trees which received a lite treatment+ND composition.

FIG. 8 shows the activation of apple defense genes expressed in log 2 of the sum of the induced defense genes, after normalization relative to a control (the control corresponds to the treatment of the seedlings with water), for apple leaves which were sampled on day 1 (D1) and day 3 (D3) post-treatment. The leaves were treated with the ND composition diluted 200-fold (v/v) or the ND composition diluted 66-fold (v/v).

FIG. 9 shows the activation of the apple defense genes PR1, PR5, PR8, PR14 and PR10 expressed in log 2 of the sum of the induced defense genes, after normalization relative to a control (the control corresponds to the treatment of the seedlings with water), for apple leaves which were sampled on day 1 (D1) post-treatment. The leaves were treated with the ND composition diluted 200-fold (v/v) or the ND composition diluted 66-fold (v/v).

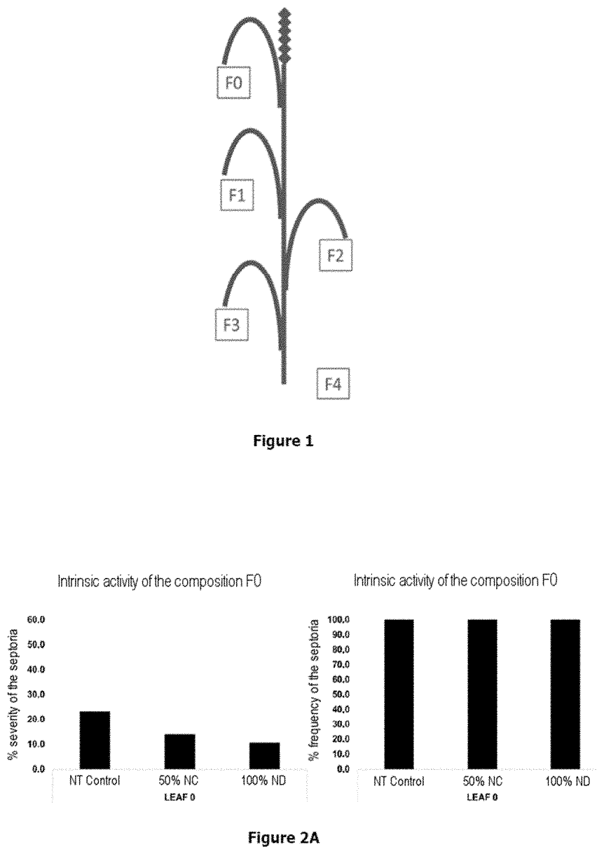

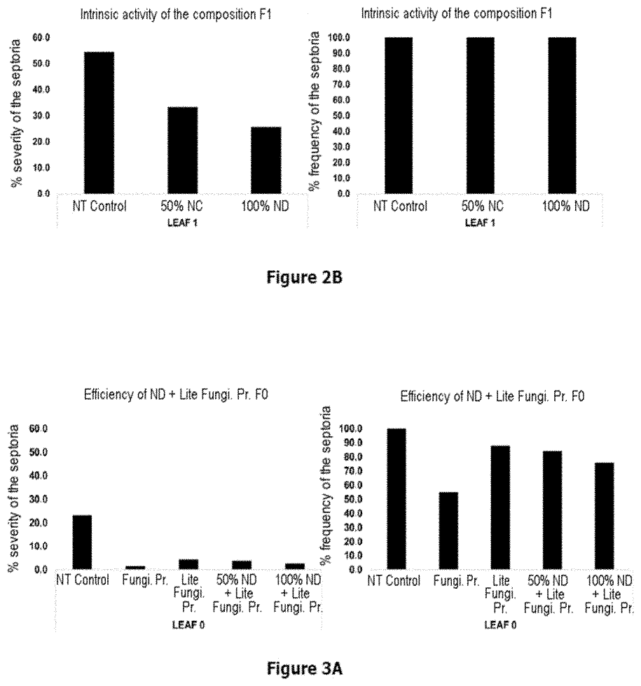

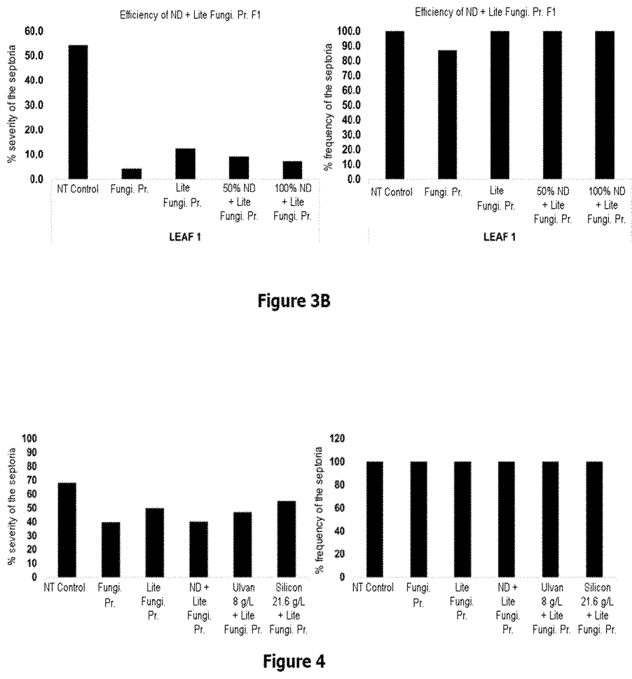

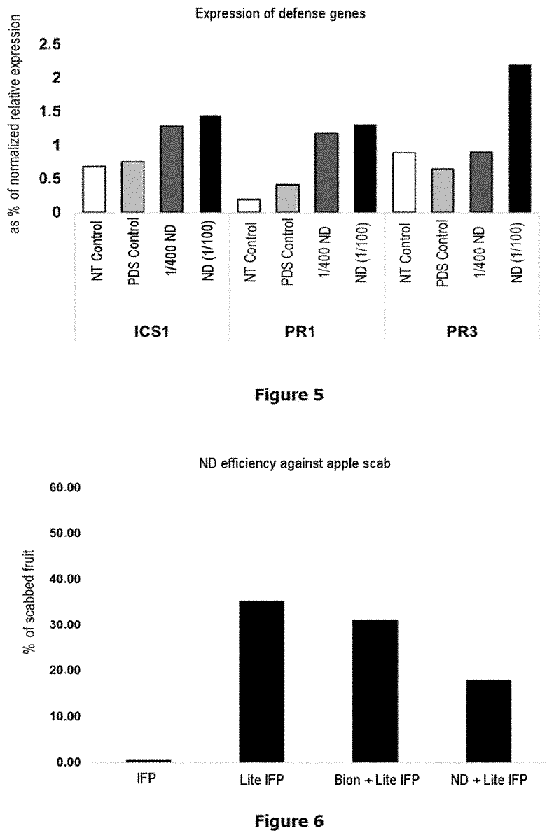

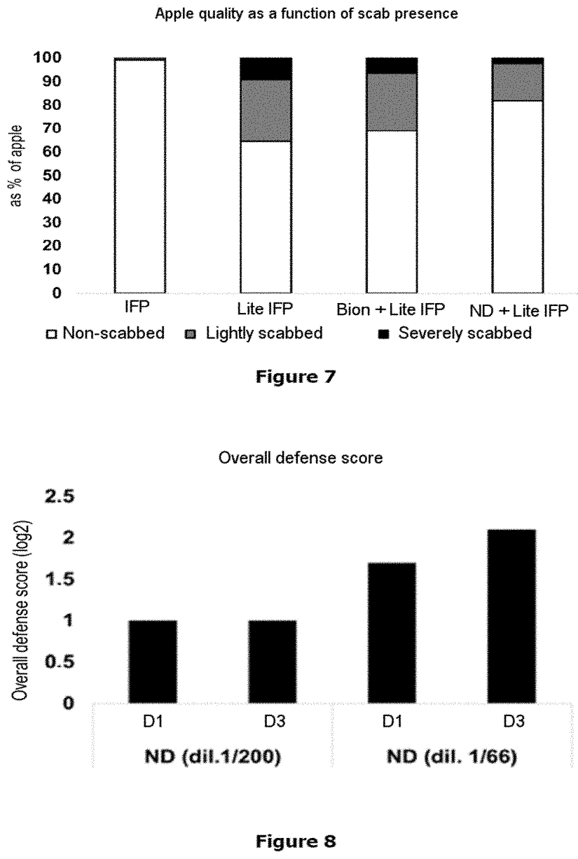

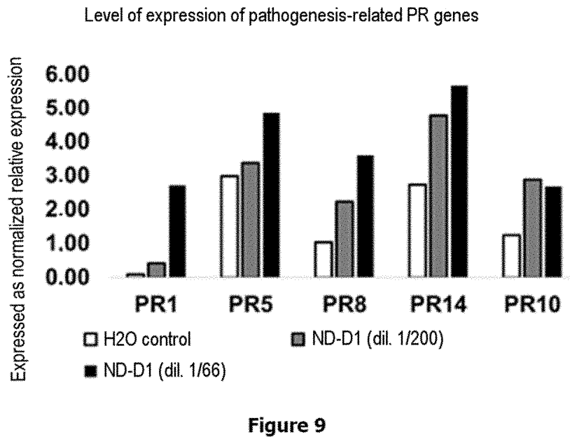

1. A phytosanitary composition comprising:
(i) ulvans and/or ulvan-derived oligosaccharides; and
(ii) silicon.

2. The phytosanitary composition according to claim 1, characterized in that the ulvans and/or ulvan-derived oligosaccharides are in the form of an extract containing ulvans and/or ulvan-derived oligosaccharides, for example an extract of Ulva or an extract of Enteromorpha.

3. The phytosanitary composition according to claim 1, characterized in that the extract containing ulvans and/or ulvan-derived oligosaccharides is an extract of Ulva armoricana, an extract of Ulva rigida, an extract of Ulva rotundata, an extract of Ulva lactuca, an extract of Enteromorpha intestinalis, or an extract of Enteromorpha compressa, preferably an extract of Ulva armoricana, an extract of Enteromorpha intestinalis or an extract of Enteromorpha compressa.

4. The phytosanitary composition according to claim 2, characterized in that the extract containing ulvans and/or ulvan-derived oligosaccharides is an extract enriched in ulvans and/or ulvan-derived oligosaccharides.

5. The phytosanitary composition according to claim 1, characterized in that the ulvan-derived oligosaccharides are obtained by acid or enzymatic hydrolysis of ulvans.

6. The phytosanitary composition according to claim 1, characterized in that the silicon is in the form of a soluble salt, preferably chosen from potassium silicate (K₂SiO₃), sodium silicate (Na₂SiO₃), or a mixture thereof.

7. The phytosanitary composition according to claim 1, characterized in that said composition is in liquid form.

8. The phytosanitary composition according to claim 1, characterized in that said composition is in liquid form and comprises:
a concentration of ulvans and/or ulvan-derived oligosaccharides of from 0.01 to 100 g/L, and
a concentration of silicon of from 0.01 g/L to 100 g/L.

9. The phytosanitary composition according to claim 1, characterized in that said composition is in liquid form and comprises:
a concentration of ulvans and/or ulvan-derived oligosaccharides of from 0.1 g/L to 50 g/L, preferentially from 1 g/L to 20 g/L, for example from 8 g/L to 14 g/L, and
a silicon concentration of from 0.1 g/L to 50 g/L, preferentially from 1.0 g/L to 30 g/L, from 10 g/L to 30 g/L, from 20 g/L to 30 g/L, from 5 to 10 g/L, from 5 to 8 g/L, for example about 21 g/L±1 g/L or 6 g/L±1 g/L.

10. The phytosanitary composition according to claim 1, characterized in that said composition comprises one or more pesticides.

11. The phytosanitary composition according to claim 10, characterized in that the pesticide(s) are one or more fungicides.

12. The phytosanitary composition according to claim 11, characterized in that the fungicide(s) are chosen from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole, difenoconazole, propiconazole tetraconazole, azoxystrobin, picoxystrobin, pyraclostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin.

13. The phytosanitary composition according to claim 11, characterized in that the fungicide(s) are chosen from chlorothalonil, fluxapyroxad, epoxiconazole, captan and dithlanon.

14-17. (canceled)

18. A method for activating a plant's defense reactions and resistance against biotic stresses, characterized in that it involves applying to said plant an effective amount of a composition according to claim 1.

19. The method according to claim 18, characterized in that the composition is delivered to a plant in an amount that is sufficient to activate said plant's defense reactions and resistance against biotic stresses, in particular for stimulating the expression of genes involved in the defense of the plant.

20. The method according to claim 18, characterized in that the composition is delivered to the plant in liquid form in foliar solutions, for example in an amount ranging from 0.001 to 100 L/ha, preferentially from 0.01 to 25 L/ha, even more preferentially from 0.1 to 10 L/ha, for example in an amount of 1 L/ha.

21. The method according to claim 18, characterized in that it also involves applying to said plant one or more pesticides, preferentially one or more fungicides.

22. A method for treating a plant to promote its development by reducing the access of pathogens to said plant or by eliminating pathogens present in the soil, said method involving applying to said plant a composition according to claim 10.

23. A method for potentiating the pesticidal effect of a pesticide, comprising utilizing the composition as defined in claim 1.

24. The method according to claim 23, characterized in that the pesticide is a fungicide, preferably chosen from chlorothalonil, fluxapyroxad, epoxiconazole, captan, dithlanon, fenbuconazole, pyradostrobin, dodine, prothioconazole, metconazole, propiconazole, cyproconazole, tebuconazole, bromuconazole, difenoconazole propiconazole, tetraconazole, azoxystrobin, picoxystrobin, pyraclostrobin, picoxystrobin, trifloxystrobin, dimoxystrobin, fluoxastrobin maneb, mancozeb, penthiopyrad, bixafen, prochloraz, benzovindiflupyr, boscalid, fenpropidin, fluopyram, spiroxamine, flutriafol, folpet, fenpropimorph, metrafenone, sulfur and laminarin.

25. The method according to claim 24, characterized in that the fungicide is chosen from chlorothalonil, fluxapyroxad, epoxiconazole, captan and dithlanon.
